(19) United States
(12) Patent Application Publication
(10) Pub. No.: US 2006/0246895 A1
(43) Pub. Date: Nov. 2, 2006

(54) Mobile device and method of adjusting a power measurement period of a received cell signal

(75) Inventor: Kil-Hyen Ryu, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/399,912

(22) Filed: Apr. 7, 2006

(30) Foreign Application Priority Data
Apr. 29, 2005 (KR) 2005-36400

(51) Int. Cl. H04Q 7/20

(52) U.S. Cl. 455/434

(57) ABSTRACT

A mobile device includes an antenna, a signal processing unit and a main processor. The mobile device increases or re-initializes the variable power measurement period based on the occurrence or frequency of cell reselections, rather than relying upon GPS information. The signal processing unit processes RF cell signals received via the antenna. The main processor enables (wakes up) the signal processing unit to measure each power level of the received cell signals and adjusts the power measurement period based on the current actual cell reselection frequency (e.g., comparing the current actual cell reselection frequency with a predetermined cell reselection mean frequency, e.g., in a standby mode). The signals include cell signals received from each base station of a corresponding serving cell and of neighboring cells.

### CLAIM FOR PRIORITY

This application claims priority under 35 U.S.C. §119 of Korean Patent Application No. 2005-36400 filed on Apr. 29, 2005 in the Korean Intellectual Property Office, the entire contents of which are herein incorporated by reference.

### BACKGROUND OF THE INVENTION

1. Field of the Invention

The present invention relates to the field of mobile communications and more specifically to a mobile communication device (e.g., cell phone) capable of variably adjusting a power measurement period of a cell signal so as to monitor and select an appropriate cell among a currently serving cell and neighboring cells, and a method of adjusting a power measurement period of a cell signal therein.

2. Description of the Related Art

In mobile communication systems (e.g., cell phones), a multiple access technique is generally employed so that a plurality of independent information may be transferred through a common channel, and examples of multiple access techniques include time division multiple access (TDMA), frequency division multiple access (FDMA), code division multiple access (CDMA) standards, etc.

Currently, each nation employs a mobile communication (cell-phone) system based on one of the above-described multiple access standards selected according to their local circumstances. In the Republic of Korea, for example, the CDMA standard is used in the mobile communication system since the CDMA standard is capable of supporting high capacity, high quality of service and high security.

The CDMA standard converts an analog voice signal to a digital signal. The CDMA standard applies a random number to the digital signal to generate a plurality of digital codes. As a result, mobile devices employing the CDMA standard may communicate with each other using their unique code.

On the other hand, regions such as Europe, China, Southeast Asia and South America largely employ the Global System for Mobile Communications (GSM) standard.

The GSM standard was created while the TDMA standard was being developed as a pan-European common standard. In the GSM standard, voice data are digitized and the digital data are compressed, and the compressed digital data are transferred through a single channel together with the voice data of other users, but the voice data of each user is transferred within a unique timeslot (i.e., time division multiplexing).

In Europe, the GSM standard has been adopted as the standard for mobile communication systems, and there are more than one billion subscribers using the GSM standard throughout the world in more than 120 countries.

In addition, the GSM standard is becoming a core system of the 3rd Generation Partnership Project (3GPP) for developing a third-generation (3G) phone standard, namely the International Mobile Telecommunications-2000 (IMT-2000) standard.

Generally, in a mobile communication system network, such as that of the GSM standard, a mobile device (e.g., cell-phone) periodically monitors and processes paging messages. Additionally, the mobile device continuously performs a power measurement process so as to select cells (e.g., towers, base station antennas) having an optimum radio connection, and the mobile device performs a cell (tower, base station antenna) reselection based on the measurement result.

The power measurement process and the cell reselection process are performed so as to maintain an optimum level of communication service regardless of movement of the mobile device or changes in the communication environment.

For example, the mobile device periodically measures a power level of signals received from each base station antenna of a corresponding serving cell and of neighboring cells in a standby mode.

Based on the measurement result, the mobile device determines the received signal having the highest power of the measured signals, and the mobile device performs the cell reselection based on that determination. Thus, the mobile device goes “camping” at the corresponding base station.

In other words, based on the power measurement result, when the power of a signal received from one of the base stations of neighboring cells is stronger than that of the signal received from the base station of the current serving cell, the mobile device camps on the neighboring cell. Thus, the mobile device performs the cell reselection. Conversely, when the power of the signal received from the base station of the current serving cell is the strongest, the mobile device maintains the camping state in the current serving cell.

Meanwhile, in order to perform the power measurement process, modules such as an RF processing circuit, a baseband modem and a microprocessor included within the mobile device consume a predetermined amount of power.

When the mobile device is in the “standby” mode, the power measurement process performed by the modules consumes a significant amount of power. Accordingly, the power measurement process for the cell monitoring consumes battery power of the mobile device even in the standby mode.

A conventional mobile device performs the power measurement process based on a fixed (predetermined) power measurement period so as to maintain quality of the communication service.

In practice, the mobile device is often not moved from a particular area while in the standby mode. For example, a user of the mobile device may be sleeping or working in an office. In such a case, the probability of the cell reselection is decreased, and the quality of the communication service is not improved by the fixed power measurement period.

Therefore, the conventional mobile device with a fixed power measurement period in the standby mode unnecessarily consumes battery power.

As the portability of the mobile devices become increasingly important, it is important that the power consumption of such devices be minimized and the battery life be prolonged.

However, the conventional method of measuring the power of the cell signal has not been able to minimize the power consumption of the battery in the mobile device.

Skyworks Solutions, Inc. disclosed a method of changing the power measurement period. The method includes changing the power measurement period using a variation ratio of a signal received from the present camping cell, a position of the mobile device and a moving speed of the mobile device. The variation ratio, the position of the mobile device and the moving speed of the mobile device are measured using a Global Positioning System (GPS).

However, the conventional method disclosed by Skyworks Solutions, Inc. requires a measurement algorithm for calculating the variation ratio of the received signal and additional hardware for performing the algorithm. Additionally, the conventional method disclosed by Skyworks Solutions, Inc. requires the GPS so as to monitor the moving speed of the mobile device and the position of the mobile device.

Accordingly, there is a need for a method of variably adjusting the power measurement period of the cell signal, that is not dependent upon a GPS, and that does not require additional hardware and additional cost.

### SUMMARY OF THE INVENTION

Various embodiments of the present invention provide mobile devices (e.g., cell-phones) capable of variably adjusting the power measurement period of a cell signal in a standby mode without depending upon a GPS.

Various embodiments of the present invention also provide methods capable of variably adjusting the power measurement period of a cell signal in the mobile device during a standby mode without depending upon a GPS.

In some embodiments of the present invention, a mobile device includes: a signal processing unit configured to process cell signals corresponding to a currently serving cell and to neighboring cells and a main processor configured to enable (i.e., “awakens”, “wakes up”) the signal processing unit to measure each power level of the cell signals based on a power measurement period, and configured to monitor whether or not a cell reselection occurred to adjust the power measurement period based on the monitoring result.

The main processor may adjust the power measurement period when a cell reselection did not occur within a predetermined time and initialize the power measurement period when the cell resection occurred within the predetermined time.

The main processor may increase the power measurement time when the cell reselection did not occur within the predetermined time, the predetermined time being determined by multiplying a cell reselection count by a cell reselection mean time, the cell reselection mean time indicating an estimated mean value of the time periods within which the cell reselection may occur, and the cell reselection count indicating a value that is initially set to a predetermined positive integer value and is decreased by one when the cell reselection does not occur within the cell reselection mean time.

The main processor may periodically receive a broadcast control channel (BCCH) data from a base station of the currently serving cell and re-initializes the power measurement when the BCCH data are changed.

The main processor may not adjust the power measurement period until a default time elapses, the default time indicating a time period during which a fixed initial value of the power measurement period is maintained.

The main processor may repeatedly decrease a cell reselection count by one if the cell reselection has not occurred within the cell reselection mean time and increase the power measurement period if the cell reselection count is equal to 0, the cell reselection mean time indicating an estimated mean value of the time periods within which the cell reselection may occur, and the cell reselection count indicating a value that is initially set to a predetermined positive integer value. For example, the main processor may increase the power measurement period by doubling the power measurement period.

The main processor may adjust the power measurement period to a maximum power measurement period when the increased power measurement period is larger than the maximum power measurement period, the maximum power measurement period indicating a maximum value of the power measurement period.

The mobile device may further include a memory configured to store parameters such as the power measurement time, the default time, the cell reselection count, the cell reselection mean time and the maximum power measurement time.

The signal processing unit may include an RF processing unit configured to perform an RF processing on the cell signals to output a baseband signal, a baseband demodulator configured to demodulate the baseband signal outputted from the RF processing unit to transfer the demodulated baseband signal to the main processor and a baseband modulator configured to modulate an internal signal transferred from the main processor to transfer the modulated internal signal to the RF processing unit.

In various other embodiments of the present invention, a mobile device includes a signal processing unit configured to process cell signals corresponding to a currently serving cell and to neighboring cells, a power measurement period generation module configured to monitor a cell reselection frequency and configured to compare the monitored cell reselection frequency with a predetermined value to adjust a power measurement period based on the comparison result and a control module configured to enable the signal processing unit to measure each power level of the cell signals per the power measurement period generated by the power measurement period generation module.

The power measurement period generation module may compare the monitored cell reselection frequency with the predetermined value to increase the power measurement period when the monitored cell reselection frequency is less than the predetermined value and initialize the power measurement period when the monitored cell reselection frequency is equal to or more than the predetermined value. For example, the predetermined value may correspond to a cell reselection mean frequency.

The control module may periodically receive a broadcast control channel (BCCH) data from a base station of the currently serving cell and re-initializes the power measurement when the BCCH data are changed.

The power measurement period generation module may count the cell reselection frequency during a default time and increase the power measurement period when the counted cell reselection frequency is less than a cell reselection mean frequency, the default time indicating a time period during which the power measurement period is maintained. For example, the power measurement period generation module may increase the power measurement period by doubling the power measurement period.

The power measurement period generation module may adjust the power measurement period to a maximum power measurement period when the increased power measurement period is more than the maximum power measurement period, the maximum power measurement period indicating a maximum value of the power measurement period.

The mobile device of claim may further includes a memory configured to store parameters such as the power measurement time, the default time, the cell reselection mean frequency, the monitored cell reselection frequency and the maximum power measurement time.

The signal processing unit may includes an RF processing unit configured to perform an RF processing on the cell signals to output a baseband signal, a baseband demodulator configured to demodulate the baseband signal outputted from the RF processing unit to transfer the demodulated baseband signal to the main processor and a baseband modulator configured to modulate an internal signal transferred from the main processor to transfer the modulated internal signal to the RF processing unit.

In various other embodiments of the present invention, a method of adjusting a power measurement period in a mobile device, the method includes measuring each power level of the cell signals corresponding to a currently serving cell and to neighboring cells based on the power measurement period, monitoring whether or not a cell reselection occurred within a predetermined time and adjusting the power measurement period based on the monitoring result.

Adjusting the power measurement period may include increasing the power measurement period when a cell reselection did not occur within the predetermined time and initializing the power measurement period when the cell resection occurred within the predetermined time. For example, the predetermined time may be determined by multiplying a cell reselection count by a cell reselection mean time, the cell reselection mean time being a constant value that indicates an estimated mean time interval during which the cell reselection occurred, and the cell reselection count indicating a value that is initially set to a predetermined positive integer value and is decreased by one when the cell reselection does not occur within the cell reselection mean time.

Monitoring whether or not a cell reselection occurred may include periodically receiving a broadcast control channel (BCCH) data from a base station of the currently serving cell and re-initializes the power measurement when the BCCH data are changed.

Adjusting the power measurement period may include not adjusting the power measurement period until a default time elapses, the default time indicating a time period during which the fixed initial power measurement period is maintained.

Adjusting the power measurement period may include repeatedly decreasing a cell reselection count by one if the cell reselection has not occurred within the cell reselection mean time and increasing the power measurement period if the cell reselection count is equal to 0, the cell reselection mean time being a value that indicates an estimated mean time interval during which the cell reselection occurred, and the cell reselection count indicating a value that is initially set to a predetermined positive integer value.

Increasing the power measurement period comprises adjusting the power measurement period to a maximum power measurement period when the increased power measurement period is larger than the maximum power measurement period, the maximum power measurement period indicating a maximum value of the power measurement period.

In various other embodiments of the present invention, a method of adjusting a power measurement period in a mobile device, the method includes measuring each power level of the cell signals corresponding to a currently serving cell and to neighboring cells based on the power measurement period, monitoring a cell reselection frequency to compare the monitored cell reselection frequency with a predetermined value and adjusting the power measurement period based on the compared result.

Monitoring the cell reselection frequency may include comparing the monitored cell reselection frequency with the predetermined value to increase the power measurement period when the monitored cell reselection frequency is less than the predetermined value and initializing the power measurement period when the monitored cell reselection frequency is equal to or more than the predetermined value. For example, the predetermined value may correspond to a cell reselection mean frequency.

Monitoring the cell reselection frequency may include periodically receiving a broadcast control channel (BCCH) data from a base station of the currently serving cell and re-initializing the power measurement when the BCCH data are changed.

Monitoring the cell reselection frequency may include counting the cell reselection frequency during a default time and increasing the power measurement period when the counted cell reselection frequency is less than a cell reselection mean frequency, the default time indicating a time period during which the power measurement period is maintained.

Increasing the power measurement period may include adjusting the power measurement period to a maximum power measurement period when the increased power measurement period is more than the maximum power measurement period, the maximum power measurement period indicating a maximum value of the power measurement period.

The adjusted power measurement period may be used as the power measurement period for measuring the power of the subsequently received cell signals in the power measurement process.

### BRIEF DESCRIPTION OF THE DRAWINGS

The above and other features of the present invention will become more apparent to persons skilled in the art when further described with reference to the attached drawings of detailed exemplary embodiments, in which like elements are indicated by like numerals, and:

FIG. 1 is a block diagram of a mobile device according to an embodiment of the present invention;

s FIG. 2 is a flowchart explaining a method of power measurement of a cell signal, performed by a main processor of the mobile device of FIG. 1;

FIG. 3 is a block diagram of a mobile device according to another exemplary embodiment of the present invention; and

FIG. 4 is a flowchart explaining a method of power measurement of a cell signal, performed by the mobile device 200 of FIG. 3.

### DESCRIPTION OF THE EXAMPLE EMBODIMENTS

Detailed illustrative embodiments of the present invention are disclosed below. However, specific structural and functional details disclosed herein are merely representative for purposes of describing example embodiments of the present invention. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular exemplary forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present.

The terminology used herein is for the purpose of describing particular embodiments and is not intended to be limiting of the invention. As used herein, the singular forms “a,” “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

### Example Embodiment 1

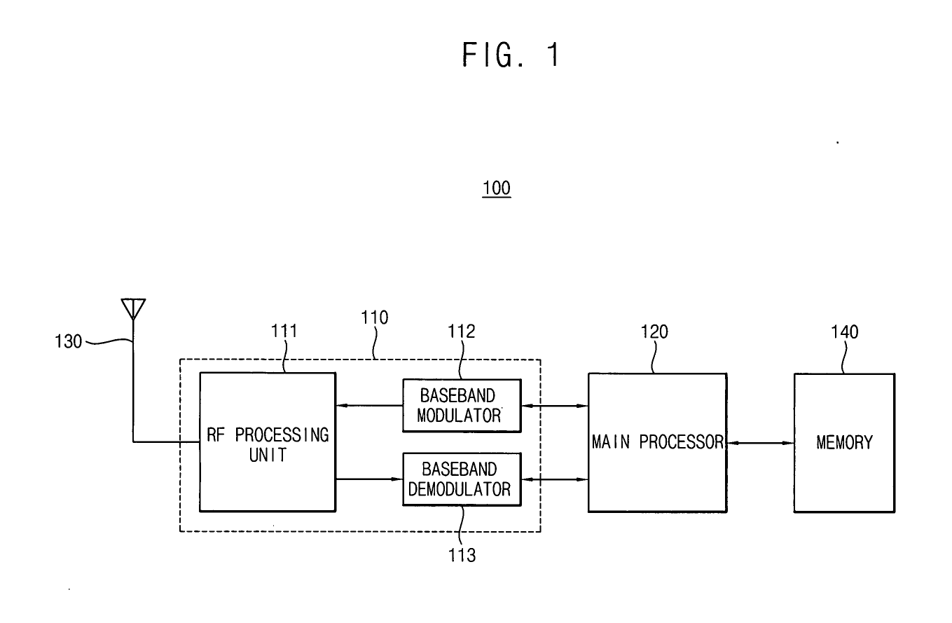

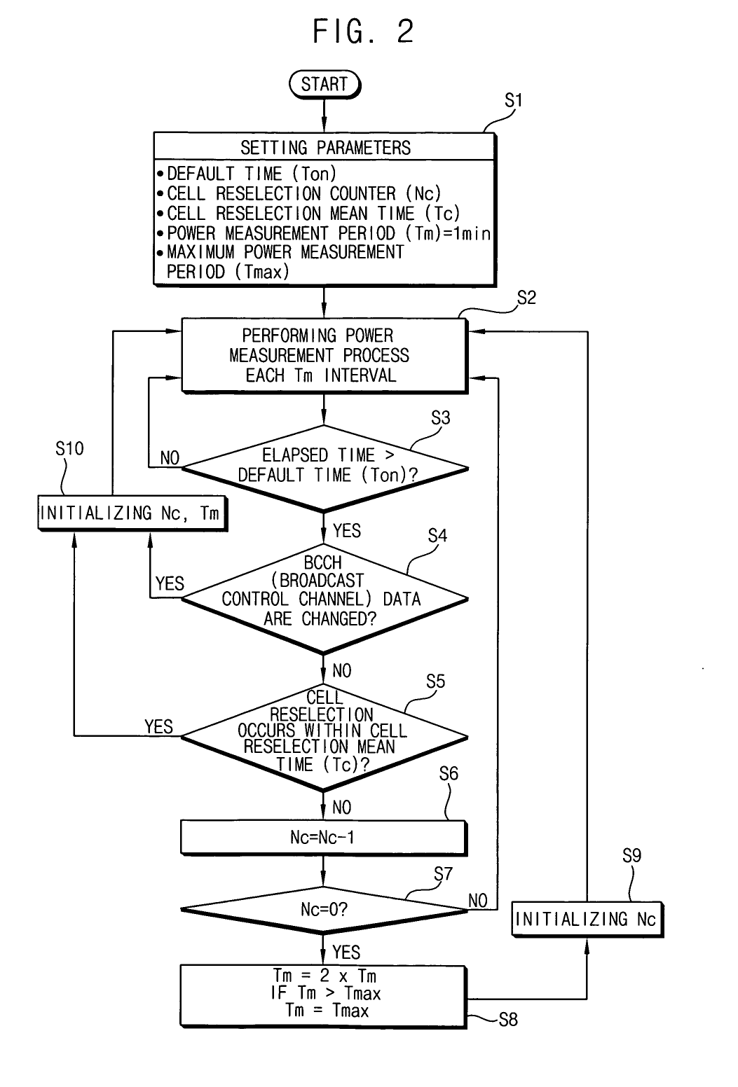

FIG. 1 is a block diagram of a mobile device (e.g., cell-phone) 100 according to an example embodiment of the present invention.

Referring to FIG. 1, the mobile device 100 includes an antenna 130, a signal processing unit 110, a main processor 120 and a memory 140.

Of course, the mobile device 100 (e.g., a cell phone) additionally includes usual elements such as a microphone, a speaker, a liquid crystal display, a keypad and so on; however, for the sake of brevity, only elements associated with illustrating the features present invention will be illustrated and described, and other elements will be omitted.

The antenna 130 transmits/receives radio frequency (RF) signals to/from a base station. More particularly, the antenna 130 receives a plurality of cell signals, that is, a “paging blocks,” from a serving cell and from neighboring cells to transmit the received cell signals to the signal processing unit 110. Additionally, the antenna 130 transfers a radio frequency (RF) signals received from the signal processing unit 110 to an external device (e.g., to the base station).

The signal processing unit 110 includes an RF processing unit 111, a baseband demodulator 113 and a baseband modulator 112.

While receiving, the RF processing unit 111 receives the cell signal having a radio frequency through the antenna 130 to perform an RF processing on the cell signal having the radio frequency. The RF processing unit 111 transfers the cell signal having a baseband frequency to the baseband demodulator 113. The baseband demodulator 113 of the signal processing unit 110 receives the baseband cell signals through the antenna 130 and converts the cell signal into an internal signal and then, transfers the internal signal to the main processor 120. Namely, the baseband demodulator 113 demodulates the cell signal having the baseband frequency output by the RF processing unit 111 to convert the cell signal having the baseband frequency to an internal signal. Then, the baseband demodulator 113 transfers the internal signal to the main processor 120.

While transmitting, the baseband modulator 112 of the signal processing unit 110 converts the internal (baseband) signal received from the main processor 120 to a radio frequency (RF) signal. Namely, the baseband modulator 112 modulates the internal signal output by the main processor 120 to transfer the modulated internal signal to the RF processing unit 111. The RF processing unit 111 receives a signal having a baseband frequency from the baseband modulator 112 to perform the RF processing on the signal having the baseband frequency. The RF processing unit 111 transfers the RF signal to the antenna 130. Thus, the signal processing unit 110 functions as a signal interface between the main processor 120 and external devices.

The memory 140 is capable of storing various data, and stores a plurality of data values used for variably adjusting the power measurement period. The data values are set and stored by the main processor 120.

The main processor 120 enables (i.e., “awakens”, “wakes up”) the signal processing unit 110 to measure the power of the cell signals received from a serving cell or from neighboring cells, and determines occurrences of a cell reselection. The main processor 120 adjusts the power measurement period based on the occurrences of the cell reselection. The main processor 120 performs basic control functions for controlling all operations of the mobile device 100.

FIG. 2 is a flowchart illustrating a method of measuring the power of received cell signals, performed by the main processor 120, according to an example embodiment of the invention.

Hereinafter, the steps of a method in which the main processor 120 adjusts (varies) the power measurement period, (e.g., for monitoring a serving cell and neighboring cells), will be described with reference to FIGS. 1 and 2.

Prior to explaining the process flow, several parameters and terms used in the process of adjusting the power measurement period of the cell signal are defined as follows:

default time (T_{ON}): The default time (T_{ON}) represents a time period during which a fixed (predetermined) initial value of the power measurement period in a default mode is maintained. For example, the predetermined time measurement period may correspond to a time period from about 10 minutes to about 30 minutes.

cell reselection mean time (Tc): The cell reselection mean time (Tc) represents a mean (average) value of the time periods within which the cell reselection may occur.

cell reselection count (Nc): The cell reselection count (Nc) is a value that is initially set to a predetermined positive integer value and is decreased by one when the cell reselection does not occur within the cell reselection mean time.

power measurement period (Tm): The power measurement period (Tm) represents a power measurement period of the cell signal.

maximum power measurement period (Tmax): The maximum power measurement period (Tmax) corresponds to a maximum value (e.g., a predetermined maximum value) of a power measurement period of a cell signal. The power measurement period (Tm) may not be larger than the maximum power measurement period (Tmax).

Before performing a procedure (e.g., method) for variably adjusting the power measurement period (Tm) of the cell signal, the main processor 120 initializes: the cell reselection count (Nc) for counting the occurrences of the cell reselection; the default time (T_{ON}) for designating a time period during which the fixed (predetermined) power measurement period in a default mode is maintained; the cell reselection mean time (Tc) representing a mean (average) value of the time periods within which the cell reselection may occur; the power measurement period (Tm); and the maximum power measurement period (Tmax). Then, the main processor 120 stores the initial (set) parameters including the cell reselection count (Nc), default time(T_{ON}), the cell reselection mean time (Tc), the power measurement period(Tm) and the maximum power measurement period (Tmax) in the memory 140 (step S1).

For example, in an initialization step, S1: the initial value of the cell reselection count (Nc) may be set to about 3; the default time (T_{ON}) may be set to about 20 minutes; the cell reselection mean time (Tc) may be set to about 7 minutes; the initial value of the power measurement period (Tm) may be set to about 1 minute and the maximum power measurement period (Tmax) may be set to about 8 minutes. It is preferable that the initial value of the power measurement period (Tm) is identical to a transmission cycle of the cell signal, i.e., the period of a paging block.

When the mobile device 100 enters into the standby mode (i.e. idle status), an operation of the mobile device 100 for variably adjusting the power measurement period of the cell signal begins to be performed. The main processor 120 enables (i.e., “awakens”, “wakes up”) the signal processing unit 110 every set (as initialized to one minute) power measurement period (Tm) to measure a power of the cell signal (step S2). Because the initial value of the power measurement period (Tm) was set to (initialized at) about 1 minute, the main processor 120 initially measures a power of the cell signal every one minute.

The main processor 120 checks whether or not the default time (T_{ON}) of about 20 minutes has elapsed after the operation of the mobile device 100 for variably adjusting the power measurement period of the cell signal begins to be performed (step S3). While the elapsed time is less than T_{ON} (e.g., about 20 minutes), the process flow goes back to repeat the step S2 (along the NO branch of decision step S3) and the main processor 120 continuously measures the power of the cell signal every Tm interval (e.g., one minute) until the elapsed time surpasses the default time (TON) of about 20 minutes. When the elapsed time is more than about 20 minutes, the process flow proceeds to a step S4 (along the YES branch of decision step S3) and the main processor 120 checks the broadcast control channel (BCCH) data (and thus obtains cell specific information about the serving cell).

After the mobile device 100 enters into the standby mode (i.e. idle state), during the default time (T_{ON}) set to about 20 minutes, the main processor 120 may monitor whether or not the cell reselection needs to occur by measuring the power of the cell signal within each fixed (predetermined) power measurement period (Tm) (i.e. about 1 minute).

Thus, the main processor 120 monitors and decides whether or not the cell reselection of the mobile device (100) shall occur by repeatedly performing a loop composed primarily of the step S2 and also of the decision step S3. During a predetermined time period (i.e., the default time (TON) set to about 20 minutes) after the mobile device 100 enters into the standby mode (i.e. idle state), the paging rate is identical to the power measurement period (Tm), for example, set to about 1 minute.

When the elapsed time exceeds the default time (TON), the main processor 120 checks the BCCH data received from the serving cell (step S4). The BCCH data includes information from the serving cell currently coupled to the mobile device 100, and the mobile device 100 typically receives both the BCCH data as well as the cell signal in the standby mode (i.e. idle state).

When the BCCH data are changed, the process flow goes back to step S2 through an intermediate re-initialization step S10 (along the YES branch of the decision step S4) and thus the main processor 120 (re)initializes the cell reselection count (Nc) and the power measurement period (Tm) to the initial value, respectively. In alternative example embodiments, the process flow may go back to initialization step S1. When the (re)initialization in the step S10 is completed, the process flow goes back to the step S2. When the BCCH data are not changed, the process flow proceeds to a step S5 (along the NO branch of the decision step S4).

The step S4 of checking the change of the BCCH data is needed to handle a worst case scenario, such as in which a quality of the communication service between the mobile device 100 and the serving cell is deteriorated when the mobile device 100 is suddenly moved at high speeds.

A detected change of the BCCH data indicates that the serving cell of the mobile device 100 has changed; and thus, after the elapsed time exceeds TZ_{ON}, the power measurement period (Tm) has to be quickly reset (e.g., to its initial value) before step S2 is performed again.

In the step S4, when the serving cell has not changed (and thus, there is no detected change of the BCCH data), the main processor 120 determines whether or not a cell reselection occurs within the cell reselection mean time (Tc) stored in the memory 140 (step S5).

When the cell reselection occurs within the cell reselection mean time (Tc), the process flow goes back to the re-initialization step S10 (along the YES branch of decision step S5) and the main processor 120 (re)initializes the cell reselection count (Nc) and the power measurement period (Tm) (e.g., to their respective initial values). When the re-initialization in step S10 is completed, the process flow goes back to the step S2.

Conversely, when a cell reselection does not occur within the cell reselection mean time (Tc), the process flow proceeds to step S6 (along the NO branch of the s decision step S5). In case a cell reselection does not occur within the cell reselection mean time (Tc), the mobile device 100 is considered to be stationary within or not moving outside of a particular area (cell). As a result, a value of the cell reselection count (Nc) is decreased by 1 (step S6), and the decreased value of the cell reselection count (Nc) becomes decremented (e.g., from initial value 3 down to 2, since the initial value of the cell reselection count (Nc) is equal to 3, or later from value 2 down to 1, or from value 1 down to 0).

After the decrement operation of the step S6 is completed, the process flow proceeds to decision step S7. In decision step S7, the main processor 120 determines whether or not the value of the cell reselection count (Nc) has become 0 (step S7). If the value of the cell reselection count (Nc) is determined as NOT 0, the process flow proceeds (loops back) to a step S2 along the NO branch of decision step S7.

Each time that steps S2 through S6 are performed, the value of the cell reselection count (Nc) may be decreased (decremented) by 1. Consequently, if the loop composed of the step S2 through the step S6 is to be performed three times in a row (i.e., without interruption by the redirection of the process through any YES branch of either of decisions steps S3, S4, or S5) then the value of the cell reselection count (Nc) becomes 0. Thus, after the portion of the loop comprising the steps S2 through S6 is performed three times, the fact (as determined by the main processor 120 in step S7) that the value of the cell reselection count (Nc) is 0 means that the mobile device 100 has not moved outside of a particular area, and that the communication environment of the mobile device 100 has not changed.

Accordingly, if the value of the cell reselection count (Nc) is determined (in step S7) as 0, the process flow proceeds to a step S8 (along the YES branch of decision step S7). In step S8, the main processor 120 increases the power measurement period (Tm) by a predetermined value. For example, the main processor 120 may increase the power measurement period (Tm) by as much as two times (that is, Tm=2Tm). After the step S8 is completed, the process flow proceeds back to step S2 through a re-initialization step S9. In the re-initialization step S9, the main processor 120 re-initializes the cell reselection count (Nc) to its initial value but does not re-initialize the power measurement period (Tm). Thus, after the re-initialization step S9 is completed, the process flow goes back to the step S2 and then a loop composed of steps S2 through S7 may be repeatedly performed.

After the elapsed time exceeds the default time (as determined in step S3) if the is BCCH data are not detected as having changed (step S4) and the cell reselection does not occur (as determined in step S5), the power measurement period (Tm) that was set to about 1 minute (e.g., in initialization step S1 or S10) may be repeatedly increased (e.g., doubled) to become a multiple of 2 of its initial value (such as 2 minutes, 4 minutes, 8 minutes and so on).

During the standby mode (idle state), when the mobile device 100 is not moved or the communication environment of the mobile device 100 is not changed, the power measurement period (Tm) of the cell signal is repeatedly increased each time that the loop comprising steps S2 through S9 is performed. As a result, the signal processing unit 110 (by the operation of which a large amount of power is consumed) is less often activated and power consumption of by the mobile device 100 may be reduced, and thus its battery's charge may be conserved.

Meanwhile, in decision step S8, if the increased power measurement period (Tm) becomes incremented larger than the maximum power measurement period (Tmax), the maximum power measurement period (Tmax) is assigned (fixed) to the maximum power measurement period (Tm=Tmax), thereby preventing the power measurement period (Tm) from being unlimitedly increased by multiples of 2. Thus, the maximum power measurement period (Tmax) is an upper limit of the power measurement period (Tm).

As described above with respect to the first example embodiment of the invention, the main processor 120 of the mobile device 100 (FIG. 1) may adjust the variable power measurement period (Tm) based solely on information received through the RF processing unit 11 of the signal processing unit 110 (FIG. 1) (e.g., information concerning whether or not a cell reselection occurs and whether or not the BCCH data are changed).

Accordingly, the mobile device 100 according to the first example embodiment of the invention may reduce power consumption and may efficiently extend battery life as compared with the performance of a conventional mobile device that measures a power of the cell signal every fixed power measurement period.

### Example Embodiment 2

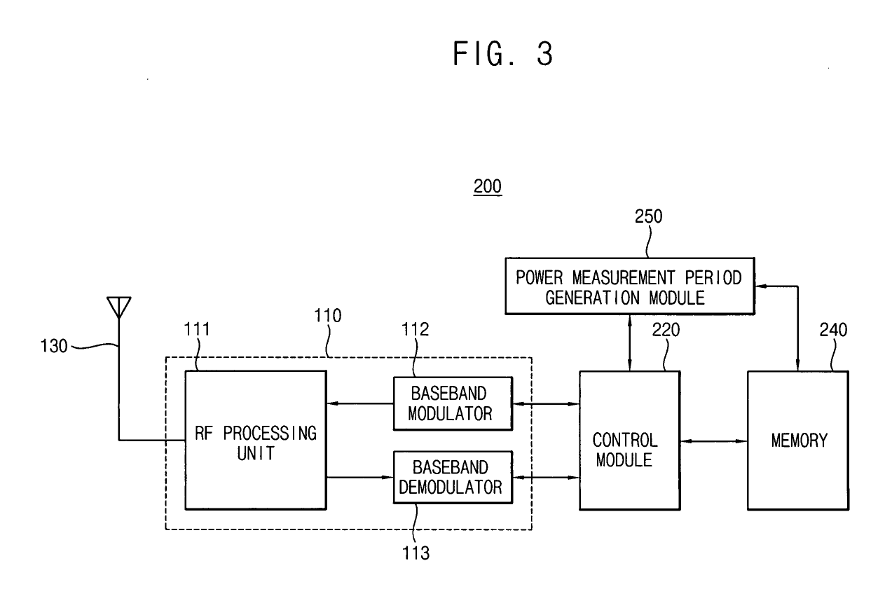

FIG. 3 is a block diagram of a mobile device 200 according to another example embodiment of the present invention.

Referring to FIG. 3, the mobile device 200 includes an antenna 130, a signal processing unit 110, a memory 240, a power measurement period generation module 250 and a control module 220. Of course, the mobile device 200 further includes usual elements such as a microphone, a speaker, a liquid crystal display device, a keypad and so on; however, for the sake of brevity, in FIG. 3 and the second example embodiment of the present invention, only elements associated with important points of the present invention will be illustrated and described, and other elements not associated with the important points of the present invention will be omitted.

The antenna 130 and the signal processing unit 110 included in the mobile device 200 of FIG. 3 have a configuration and functions identical to those included in the mobile device 100 of FIG. 1, respectively.

The antenna 130 transmits/receives radio frequency (RF) signals to/from a base station. More particularly, the antenna 130 receives a plurality of cell signals, that is, a “paging blocks,” from a serving cell and from neighboring cells to transmit the received cell signals to the signal processing unit 110. Additionally, the antenna 130 transfers a radio frequency (RF) signals received from the signal processing unit 110 to an external device (e.g., to the base station).

The signal processing unit 110 includes an RF processing unit 111, a baseband demodulator 113 and a baseband modulator 112.

While receiving, the RF processing unit 111 receives the cell signal having a radio frequency through the antenna 130 to perform an RF processing on the cell signal having the radio frequency. The RF processing unit 111 transfers the cell signal having a baseband frequency to the baseband demodulator 113. The baseband demodulator 113 of the signal processing unit 110 receives the baseband cell signals through the antenna 130 and converts the cell signal into an internal signal and then, transfers the internal signal to the main processor 120. Namely, the baseband demodulator 113 demodulates the cell signal having the baseband frequency output by the RF processing unit 111 to convert the cell signal having the baseband frequency to an internal signal. Then, the baseband demodulator 113 transfers the internal signal to the control module 220.

While transmitting, the baseband modulator 112 of the signal processing unit 110 converts the internal (baseband) signal received from the control module 220 to a radio frequency (RF) signal. Namely, the baseband modulator 112 modulates the internal signal output by the control module 220 to transfer the modulated internal signal to the RF processing unit 111. The RF processing unit 111 receives a signal having a baseband frequency from the baseband modulator 112 to perform the RF processing on the signal having the baseband frequency. The RF processing unit 111 transfers the RF signal to the antenna 130. Thus, the signal processing unit 110 functions as a signal interface between the control module 220 and external devices.

The memory 240 is capable of storing various data, and stores a plurality of data values used for variably adjusting the power measurement period. The data values may be set and stored by the power measurement period generation module 250 and the control module 220.

The power measurement period generation module 250 cooperates with the memory 240 and the control module 220, and variably adjusts a power measurement period (Tm) based on a comparison of the cell reselection mean frequency and the cell reselection frequency occurred during a predetermined time. The cell reselection mean frequency may be a predetermined value.

The control module 220 enables (i.e., “awakens”, “wakes up”) the signal processing unit 110 (based on a power measurement period generated by the power measurement period generation module 250) to measure the power of the cell signal received from each base station of the serving cell and of neighboring cells, and performs a cell reselection if the control module 220 determines that a cell reselection is to be performed. The control module 220 performs fundamental control functions related to cell reselection and may perform fundamental control functions for controlling all of the operations of the mobile device 200.

The power measurement period generation module 250 and the control module 220 may be implemented by a single microprocessor in software, or by two microprocessors on a chip, or by one microprocessor and a finite-state machine, etc.

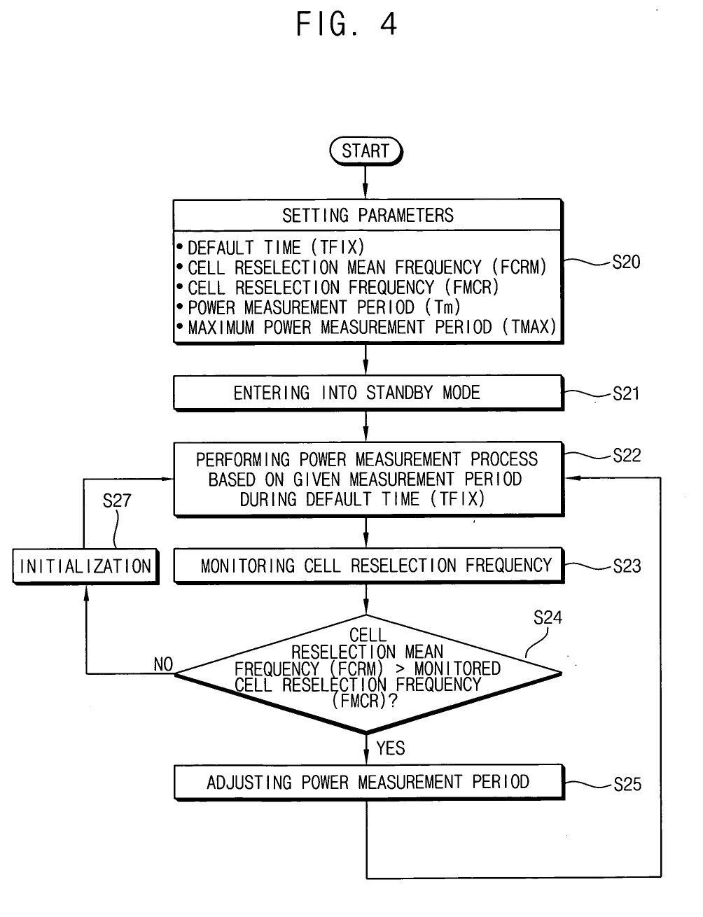

FIG. 4 is a flowchart of a method of power measurement of a cell signal performed by the mobile device 200 of FIG. 3.

Prior to explaining the flow of steps of the method, several parameters and terms used for variably adjusting the power measurement period of the cell signal are defined as follows.

default time (T_{FIX}): The default time (T_{FIX}) represents a time period during which the initial or adjusted power measurement period (Tm) is maintained. For example, the default time (T_{FIX}) may correspond to 30 minutes.

cell reselection mean frequency (F_{CRM}): The cell reselection mean frequency (F_{CRM}) may be set based on an average of the cell reselection frequency measured in the past, and the cell reselection mean frequency (F_{CRM}) is provided as a reference value for determining whether or not the power measurement period Tm of the cell signal is adjusted.

power measurement period (Tm): The power measurement period (Tm) represents a power measurement period of the cell signal.

maximum power measurement period (T_{MAX}): The maximum power measurement period (T_{MAX}) represents a maximum value of the power measurement period, and thus the maximum power measurement period (T_{MAX}) is an upper limit of the power measurement period (Tm).

monitored (actual) cell reselection frequency (F_{MCR}): The monitored cell reselection frequency (F_{MCR}) represents a (actual) frequency monitored during the power measurement period (Tm).

Hereinafter, with reference to FIGS. 3 and 4, the flow of the steps of the method by which the mobile device 200 measures the power of the cell signals received from its serving cell and from neighboring cells (e.g., by variably adjusting a power measurement period), will be described.

The power measurement period generation module 250 initializes the default time (T_{FIX}), the cell reselection mean frequency (F_{CRM}), the power measurement period (Tm) and the maximum power measurement period (T_{MAX}). It is preferable that the initial power measurement period (T_{IMP}) is identical to a transmission cycle of the cell signal, i.e., the paging block.

When the mobile device 200 enters into the standby mode (idle state) (step S21), the control module 220 performs a power measurement process (step S22) based on the initial power measurement period (Tm) during the default time (T_{FIX}).

When the power measurement process is completed by the control module 220, the power measurement period generation module 250 performs a step of monitoring the cell reselection frequency (step S23), a step of comparing the cell reselection mean frequency (F_{CRM}) with the monitored cell reselection frequency (F_{MCR}) (S24), and a step of variably adjusting the power measurement period (Tm) (S25).

The power measurement period generation module 250 adjusts the power measurement period (Tm) by repeatedly performing a loop comprised of steps S22 through S25.

Hereinafter, a first loop (comprised of steps S22 through S25) is explained below.

The control module 220 performs a power measurement process based on a given power measurement period during the default time (T_{FIX}) (step S22).

The control module 220 enables (i.e., “awakens”, “wakes up”) the signal processing unit 110 to measure the power of the cell signal based on the power measurement period (Tm) generated by the power measurement period generation module 250. During the power measurement process performed by the control module 220, the power measurement period generation module 250 may monitor the cell reselection frequency (step S23).

The power measurement period generation module 250 compares the monitored (actual, current) cell reselection frequency (F_{MCR}) with the cell reselection mean frequency (F_{CRM}) (step S24).

When the monitored cell reselection frequency (F_{MCR}) is lower than the cell reselection mean frequency (F_{CRM}), the power measurement period (Tm) is increased by a predetermined value. For example, the power measurement period (Tm) may be increased by two times the previous power measurement period (Tm) (step S25). After the adjustment step S25 is completed, the process flow goes back to the step S22. Conversely, when the monitored cell reselection frequency (F_{MCR}) is higher than the cell reselection mean frequency (F_{CRM}), the process flow goes back to the step S22 via a re-initialization step S27 (without performing the adjustment step S25).

Accordingly, when the monitored (actual, current) cell reselection frequency (F_{MCR}) is higher than the cell reselection mean frequency (F_{CRM}), the power measurement period (Tm) does not vary, and when the monitored cell reselection frequency (F_{MCR}) is lower than the cell reselection mean frequency (F_{CRM}), the power measurement period (Tm) may be increased by two times the previous power measurement period (Tm).

Meanwhile, after the power measurement period (Tm) is increased by two times the previous power measurement period (Tm) (in the step S25 of the first performance of the loop), a subsequent (e.g., a second performance of the loop) will be performed as follows.

The control module 220 enables (i.e., “awakens”, “wakes up”) the signal processing unit 110 based on the power measurement period (Tm) generated by the power measurement period generation module 250 to measure the power of the cell signal (step S22). During the power measurement process performed by the control module 220, the power measurement period generation module 250 may monitor the cell reselection frequency (step S23).

The power measurement period generation module 250 compares the monitored (actual, current) cell reselection frequency (F_{MCR}) with the cell reselection mean frequency (F_{CRM}) set in the memory 240 (step S24).

When the monitored (actual, current) cell reselection frequency (F_{MCR}) is lower than the cell reselection mean frequency (F_{CRM}), the power measurement period (Tm) is increased by two times the previous power measurement period (Tm) (step S25). After the step S25 is completed, the process flow goes back to perform step S22. Thus, the loop is performed a third time.

Conversely, when the monitored (actual, current) cell reselection frequency (F_{MCR}) is higher than the cell reselection mean frequency (F_{CRM}), the power measurement period (Tm) is re-initialized in re-initialization step S27. After the re-initialization step S27 is completed, the process flow goes back to the power measurement step S22. Thus, the loop is performed again.

Consequently, when the monitored (actual, current) cell reselection frequency (F_{MCR}) is again lower than the cell reselection mean frequency (F_{CRM}), the power measurement period (Tm) is adjusted to four times the initial power measurement period (Tm); but when the monitored cell reselection frequency (F_{MCR}) is higher than the cell reselection mean frequency (F_{CRM}), the power measurement period (Tm) is re-initialized.

Meanwhile, when the loop composed of the step S22 through the step S25 is repeatedly performed (without interruption by re-initialization step S27), the power measurement period (Tm) may be unlimitedly increased. In order to prevent the power measurement period (Tm) from being unlimitedly increased, in step S25, the power measurement period (Tm) is compared with the maximum power measurement period (T_{MAX}). When the power measurement period (Tm) is greater than the maximum power measurement period (T_{MAX}), the power measurement period (Tm) is fixed at the maximum power measurement period (T_{MAX}). Thus, the power measurement period (Tm) may not be greater than the maximum power measurement period (T_{MAX}).

The mobile device 200 (FIG. 1) receives the broadcast control channel (BCCH) data including information from the serving cell currently coupled to the mobile device 200. The power measurement period generation module 250 periodically monitors the BCCH data, and when the BCCH data are changed, the power measurement period generation module 250 initializes the power measurement period (Tm), and, the initialization step S20 and the loop is performed, again.

The step of checking the change of the BCCH data is needed to handle a worst-case scenario, such as where the quality of the communication service between the mobile device 200 and the serving cell may be deteriorated when the mobile device 200 is suddenly moved at high speeds away from the serving cell area.

As described above, the mobile devices 100 (FIG. 1) and 200 (FIG. 2) according to example embodiments of the invention may variably adjust the power measurement period of the cell signal based solely upon the information received through the RF processing unit 11 of the signal processing unit 110 (FIG. 1) (e.g., information concerning whether or not the cell reselection occurs and concerning the monitored cell reselection frequency (F_{MCR}) in the standby mode).

Accordingly, the mobile devices 100 (FIG. 1) and 200 (FIG. 2) according to the example embodiments of the present invention may reduce power consumption and may efficiently extend battery life as compared with the conventional mobile device that measures the power of the cell signal every fixed power measurement period.

In the example embodiments of the present invention, the power measurement period is increased by any integral multiple of 2; however, in alternative example embodiments, the power measurement period may be increased in a variety of manners, such as: simple incrementation (e.g., Tm=Tm+1) logarithmic increase (e.g., Tm=Tm×X^{y}); Fibonacci number series, etc. or by arbitrary incrementation tables or scales. Therefore, it should be understood that various changes, substitutions and alterations may be made herein without departing from the scope of the invention.

As described above, a mobile device according to some embodiments of the present invention may be capable of variably adjusting the variable power measurement period of the cell signal in the standby mode. Therefore, the mobile device may reduce power consumption to extend battery life.

Furthermore, because the method of adjusting the variable power measurement period in the mobile device according to embodiments of the present invention may be more simply implemented in a microprocessor at a software level, conventional dependency upon cooperation with a global positioning system (GPS) may not be required, and a simple circuit design may be achieved, and additional hardware and high-cost devices may be avoided.

While the example embodiments of the present invention have been described in detail, it should be understood that various changes, substitutions and alterations may be made herein without departing from the scope of the invention.

What is claimed is:

1. A mobile device comprising:
a signal processing unit configured to process cell signals corresponding to a currently serving cell and to neighboring cells; and
a main processor configured to enable the signal processing unit to measure each power level of the cell signals based on a power measurement period, and configured to monitor whether or not a cell reselection occurred to adjust the power measurement period based on the monitoring result.

2. The mobile device of claim 1, wherein the main processor adjusts the power measurement period when the cell reselection did not occur within a predetermined time and initializes the power measurement period when the cell resection occurred within the predetermined time.

3. The mobile device of claim 2, wherein the main processor increases the power measurement time when the cell reselection did not occur within the predetermined time, the predetermined time being determined by multiplying a cell reselection count by a cell reselection mean time, the cell reselection mean time indicating an estimated mean value of the time periods within which the cell reselection may occur, and the cell reselection count indicating a value that is initially set to a predetermined positive integer value and is decreased by one when the cell reselection does not occur within the cell reselection mean time.

4. The mobile device of claim 1, wherein the main processor periodically receives a broadcast control channel (BCCH) data from the currently serving cell and re-initializes the power measurement period when the BCCH data are changed.

5. The mobile device of claim 1, wherein the main processor does not adjust the power measurement period until a default time elapses, the default time indicating a time period during which a fixed initial value of the power measurement period is maintained.

6. The mobile device of claim 5, wherein the main processor repeatedly decreases a cell reselection count by one if the cell reselection does not occur within a cell reselection mean time and increases the power measurement period if the cell reselection count is equal to 0, the cell reselection mean time an estimated mean value of the time periods within which the cell reselection may occur, and the cell reselection count indicating a value that is initially set to a predetermined positive integer value.

7. The mobile device of claim 6, wherein the main processor increases the power measurement period by doubling the power measurement period.

8. The mobile device of claim 6, wherein the main processor adjusts the power measurement period to a maximum power measurement period when the increased power measurement period is larger than the maximum power measurement period, the maximum power measurement period indicating a maximum value of the power measurement period.

9. The mobile device of claim 8, further comprising:
a memory configured to store parameters such as the power measurement time, the default time, the cell reselection count, the cell reselection mean time and the maximum power measurement time.

10. The mobile device of claim 1, wherein the signal processing unit comprises:
an RF processing unit configured to perform an RF processing on the cell signals to output a baseband signal;
a baseband demodulator configured to demodulate the baseband signal outputted from the RF processing unit to transfer the demodulated baseband signal to the main processor; and
baseband modulator configured to modulate an internal signal transferred from the main processor to transfer the modulated internal signal to the RF processing unit.

11. A mobile device comprising:
a signal processing unit configured to process cell signals corresponding to a currently serving cell and to neighboring cells;
a power measurement period generation module configured to monitor a cell reselection frequency and configured to compare the monitored cell reselection frequency with a predetermined value to adjust a power measurement period based on the comparison result; and
a control module configured to enable the signal processing unit to measure each power level of the cell signals per the power measurement period generated by the power measurement period generation module.

12. The mobile device of claim 11, wherein the power measurement period generation module compares the monitored cell reselection frequency with the predetermined value to increase the power measurement period when the monitored cell reselection frequency is less than the predetermined value and to initialize the power measurement period when the monitored cell reselection frequency is equal to or more than the predetermined value.

13. The mobile device of claim 12, wherein the predetermined value corresponds to a cell reselection mean frequency.

14. The mobile device of claim 11, wherein the control module periodically receives a broadcast control channel (BCCH) data from the currently serving cell and re-initializes the power measurement when the BCCH data are changed.

15. The mobile device of claim 14, wherein the power measurement period generation module counts the cell reselection frequency during a default time and increases the power measurement period when the counted cell reselection frequency is less than a cell reselection mean frequency, the default time indicating a time period during which the power measurement period is maintained.

16. The mobile device of claim 15, wherein the power measurement period generation module increases the power measurement period by doubling the power measurement period.

17. The mobile device of claim 15, wherein the power measurement period generation module adjusts the power measurement period to a maximum power measurement period when the increased power measurement period is more than the maximum power measurement period, the maximum power measurement period indicating a maximum value of the power measurement period.

18. The mobile device of claim 17, further comprising:
a memory configured to store parameters such as the power measurement period, the default time, the cell reselection mean frequency, the monitored cell reselection frequency and the maximum power measurement time.

19. The mobile device of claim 11, wherein the signal processing unit comprises:
an RF processing unit configured to perform an RF processing on the cell signals to output a baseband signal;
a baseband demodulator configured to demodulate the baseband signal outputted from the RF processing unit to transfer the demodulated baseband signal to the main processor; and
a baseband modulator configured to modulate an internal signal transferred from the main processor to transfer the modulated internal signal to the RF processing unit.

20. A method of adjusting a power measurement period in a mobile device, the method comprising:
measuring each power level of cell signals corresponding to a currently serving cell and to neighboring cells based on the power measurement period;
monitoring whether or not a cell reselection occurred within a predetermined time; and
adjusting the power measurement period based on the monitoring result.

21. The method of claim 20, wherein adjusting the power measurement period comprises increasing the power measurement period when the cell reselection did not occur within the predetermined time and initializing the power measurement period when the cell resection occurred within the predetermined time.

22. The method of claim 21, wherein the predetermined time is determined by multiplying a cell reselection count by a cell reselection mean time, the cell reselection mean time indicating an estimated mean value of the time periods within which the cell reselection may occur, and the cell reselection count indicating a value that is initially set to a predetermined positive integer value and is decreased by one when the cell reselection does not occur within the cell reselection mean time.

23. The method of claim 20, wherein monitoring whether or not the cell reselection occurred comprises periodically receiving a broadcast control channel (BCCH) data from the currently serving cell and re-initializes the power measurement when the BCCH data are changed.

24. The method of claim 23, wherein adjusting the power measurement period comprises not adjusting the power measurement period until a default time elapses, the default time indicating a time period during which the fixed initial power measurement period is maintained.

25. The method of claim 24, wherein adjusting the power measurement period comprises repeatedly decreasing a cell reselection count by one if the cell reselection has not occurred within the cell reselection mean time and increasing the power measurement period if the cell reselection count is equal to 0, the cell reselection mean time indicating an estimated mean value of the time periods within which the cell reselection may occur, and the cell reselection count indicating a value that is initially set to a predetermined positive integer value.

26. The mobile device of claim 25, wherein increasing the power measurement period comprises adjusting the power measurement period to a maximum power measurement period when the increased power measurement period is larger than the maximum power measurement period, the maximum power measurement period indicating a maximum value of the power measurement period.

27. A method of adjusting a power measurement period in a mobile device, the method comprising:
measuring each power level of the cell signals corresponding to a currently serving cell and to neighboring cells based on the power measurement period;
monitoring a cell reselection frequency to compare the monitored cell reselection frequency with a predetermined value; and
adjusting the power measurement period based on the compared result.

28. The method of claim 27, wherein monitoring the cell reselection frequency comprises comparing the monitored cell reselection frequency with the predetermined value to increase the power measurement period when the monitored cell reselection frequency is less than the predetermined value and initializing the power measurement period when the monitored cell reselection frequency is equal to or more than the predetermined value.

29. The method of claim 28, wherein the predetermined value corresponds to a cell reselection mean frequency.

30. The method of claim 27, wherein monitoring the cell reselection frequency comprises periodically receiving a broadcast control channel (BCCH) data from the currently serving cell and re-initializing the power measurement when the BCCH data are changed.

31. The method of claim 30, wherein monitoring the cell reselection frequency comprises counting the cell reselection frequency during a default time and increasing the power measurement period when the counted cell reselection frequency is less than a cell reselection mean frequency, the default time indicating a time period during which the power measurement period is maintained.

32. The method of claim 31, wherein increasing the power measurement period comprises adjusting the power measurement period to a maximum power measurement period when the increased power measurement period is more than the maximum power measurement period, the maximum power measurement period indicating a maximum value of the power measurement period.
